(19) United States
(12) Patent Application Publication
(10) Pub. No.: US 2012/0130876 A1
(43) Pub. Date: May 24, 2012

(54) System, Method and computer program for operating web-based collective e-money lending/borrowing circles between members and non-members of social networking websites

(76) Inventor: Andre Wesley Voisin, London (GB)

(21) Appl. No.: 12/948,893

(22) Filed: Nov. 18, 2010

(51) Int. Cl. G06Q 40/00

(52) U.S. Cl. 705/35

(57) ABSTRACT

A system, method and computer program for implementing a web based solution, allowing members of a social networking website and/or the general public to carry out trust based collective e-money lending/borrowing circles called ‘PartnerHands’, in which members divide the cost of a larger amount of e-money, equally between themselves and collectively pay in the smaller amounts over a mutually agreed period of time. Each member of the group then takes a turn in skipping one payment and receiving the full amount as an interest free loan. Once everybody within the PartnerHand has received the collective amount once the PartnerHand agreement ends.

### BACKGROUND OF THE INVENTION

1. Field of the Invention

The present invention relates generally to the current trend of social networking and the age old system of lending and borrowing money. In particular it focuses on a system and method for incorporating the two fields together resulting in a new system for using an individual's social network to arrange mutually beneficial loan agreements.

2. Description of Related Art

Traditionally, people have loaned money through peer to peer lending; in ancient times the act of usury, adding interest to a loan, led to the extortionate interest rates we see in banking today. In order to take out loans, banks and such, check an individuals creditworthiness through bureaus such as Equifax; which doesn't always give a fair portrayal of a person who may be classed as having ‘poor credit’ simply because they have never had to apply for credit before.

However in today's current financial climate we see economy in various countries taking a steep nosedive, more recently due to the globally felt ‘credit crunch’ which has led to a high influx of applications for credit; but huge disappointment when refused by banks, whom themselves are being very stringent nowadays on who gets credit.

On the other hand a large number of people are joining social networking sites, some sites boasting more than 500 million active members worldwide.

The invention of a online solution offering ‘social lending’ is inevitable with such a downturn in the availability of financial loans yet a surge in the market of social networking sites. A site operating PartnerHand agreements will support the growing trend in alternatives to traditional lending, especially as it gives members the flexibility of determining their repayment dates yet keeps the loans interest free for the life of the loan.

### SUMMARY OF THE INVENTION

The present invention provides a system, method and computer program for implementing a web based solution, allowing members of a social networking website and/or the general public to carry out trust based collective e-money lending/borrowing circles called ‘PartnerHands’, in which members divide the cost of a larger amount of e-money, equally between themselves and collectively pay in the smaller amounts over a mutually agreed period of time. Each member of the group then takes a turn in skipping a payment and receiving the full amount as an interest free loan.

### BRIEF DESCRIPTION OF THE DRAWING

FIG. 1 is a diagram of the PartnerHand system for a PartnerHand containing five members with a net worth of £5000.

### DETAILED DESCRIPTION

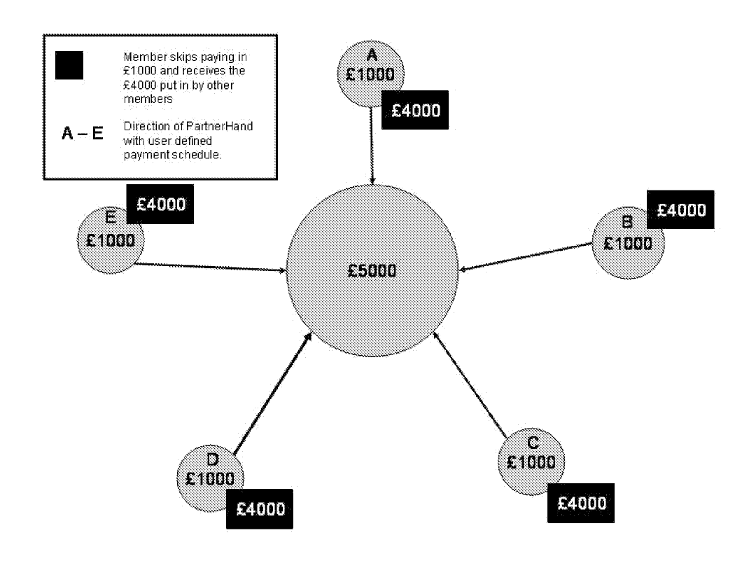

FIG. 1 is a diagram displaying the flow system of a PartnerHand worth £5000 between five members. The letters A-E is an indicator of the direction of the payments and payouts (alphabetical order) and it also represents a time period formally agreed between all five members, in this instance ‘every three months’.

So Person A skips a payment of £1000 and receives the full purse of £4000, adding their own withheld e-money brings the total to £5000.

Three months later Person B skips a payment of £1000 and receives the full purse of £4000, adding their own withheld e-money brings the total to £5000.

Three months later Person C skips a payment of £1000 and receives the full purse of £4000, adding their own withheld e-money brings the total to £5000.

Three months later Person D skips a payment of £1000 and receives the full purse of £4000, adding their own withheld e-money brings the total to £5000.

Three months later Person E skips a payment of £1000 and receives the full purse of £4000, adding their own withheld e-money brings the total to £5000 and marks the end of the PartnerHand agreement.

1. A method for implementing a web based solution operating trust based collective e-money lending/borrowing circles called PartnerHands between members of social networking websites and/or the general public.

2. The method recited in claim 1, wherein members divide the cost of a larger amount of e-money, equally amongst themselves and collectively pay in the smaller amounts over a mutually agreed period of time.

3. The method recited in claim 1, wherein each member of the group then takes a turn in skipping one payment and receiving the full amount as an interest free loan.

4. The method recited in claim 1, wherein upon successful completion of a PartnerHand agreement a users online ‘trust rating’ rises, raising any credit limits, allowing them to carry out PartnerHands with a higher net worth.

5. The method recited in claim 1, wherein users can top up an ‘e-vault’ with e-money which acts as a financial guarantee for other members of the PartnerHand should the owner of the e-vault default a payment.

6. A system for generating a web based collective e-money lending/borrowing circle between members of social networking sites and/or the general public, comprising: a communications interface configured to receive a plurality of data items associated with members of a PartnerHand.

7. The system recited in claim 6, further comprising a display module configured to generate a display of past and present existing PartnerHands.

8. The system recited in claim 6, further comprising a display module of a PartnerHand's net worth, member details, payout dates and financial guarantees.

9. The system recited in claim 6, further comprising a display module of a users e-vault worth and trust rating.

10. A computer readable medium having embodied thereon a program, the program being executable by a processor for performing a method for implementing a web based solution operating trust based collective e-money lending/borrowing circles called PartnerHands between members of social networking websites and/or the general public; the method comprising: a communications interface configured to receive a plurality of data items associated with members of a PartnerHand.

11. The computer readable medium recited in claim 10, wherein the method further comprises a display module configured to generate a display of past and present existing PartnerHands.

12. The computer readable medium recited in claim 10, wherein the method further comprises a display module of a PartnerHand's net worth, member details, payout dates and financial guarantees.

13. The computer readable medium recited in claim 10, wherein the method further comprises a display module of a users e-vault worth and trust rating.
